(19) United States
(12) Patent Application Publication
(10) Pub. No.: US 2017/0015193 A1
(43) Pub. Date: Jan. 19, 2017

(54) Flow Guiding Mechanism for a Tank Filler Neck

(71) Applicant: MAGNA STEYR Fuel Systems GesmbH, Sinabelkirchen (AT)

(72) Inventor: René HENDLER, Graz (AT)

(21) Appl. No.: 15/210,998

(22) Filed: Jul. 15, 2016

(30) Foreign Application Priority Data
Jul. 16, 2015 (EP) 15177009.6

(51) Int. Cl. B60K 15/04

(52) U.S. Cl. CPC B60K 15/04; B60K 2015/048

(57) ABSTRACT

A flow guide for a tank filler neck, a tank filler neck for a motor vehicle, and a motor vehicle having a tank filler neck. The tank filler neck includes a filling tube, a filler head surrounding the filling tube at the end thereof, a seal composed of an elastomer arranged between the filling tube and the filler head, and a flow guide of arranged in the filling tube or the filler head.

### CROSS-REFERENCE TO RELATED APPLICATIONS

The present application claims priority 35 U.S.C. §119 to European Patent Publication No. EP 15177009.6 (filed on Jul. 16, 2015), which is hereby incorporated by reference in its entirety.

### TECHNICAL FIELD

Embodiments relate to a flow guide for a tank filler neck, a tank filler neck for a motor vehicle, and a motor vehicle having a tank filler neck. The tank filler neck comprises a filling tube, a filler head surrounding the filling tube at the end thereof, a seal composed of an elastomer arranged between the filling tube and the filler head, and a flow guide of said type arranged in the filling tube or the filler head.

### BACKGROUND

A flow guide of the stated type is known in principle from the prior art. For example, German Patent Publication No. DE 20 2011 109 524 U1 discloses, in this regard, a filling tube arrangement for a tank of a motor vehicle having an immersion tube, which extends into the tank, and having a guide element, arranged within an accessible region of the filling tube arrangement, for a dispensing tube of a fuel pump nozzle, and having a cap part, on which the guide element is held.

German Patent Publication No. DE 10 2008 054 247 A1 furthermore discloses a fuel tank for a motor vehicle having a filler stub, which comprises a flexible hose that is arranged in the tank, extends as far as the inner tank bottom and, at the free, lower end, has an axial outlet opening facing the inner tank bottom.

According to the related art, the guide element or flow guide is manufactured from plastic (e.g. from polyacetyl, or POM for short, or from high-density polyethylene, or HDPE for short) and from metal, and therefore, the components obtained are relatively rigid. The selected tolerances of the individual components of a tank filler neck are therefore relatively narrow to enable trouble-free assembly of the components to be achieved. However, particularly the production process (blowing process) for the plastic filling tube is difficult to control and, in particular, the internal geometry of the filling tube is difficult to reproduce. Contrary to the postulated requirement, the filling tube thus has very large tolerances, making the assembly of the components of a tank filler neck more difficult.

Another disadvantage of the known tank filler necks is the virtual impossibility of using the same components for different models, with the possible exception of the filler head and the sealing ring. However, in almost all cases the filling tube and the flow guides must be matched to the conditions in the respective vehicle.

### SUMMARY

Embodiments relate to an improved flow guide, an improved tank filler neck and an improved motor vehicle. In particular, embodiments are to facilitate assembly of the individual components of a tank filler neck, and also to permit use of more components than hitherto for different models.

In accordance with embodiments, a flow guide of the type stated at the outset which is composed at least partially of an elastomer or of a thermoplastic elastomer. For example, nitrile rubber (NBR), fluorocarbon rubber (FKM) or fluorosilicone (FVMQ) can be used as the elastomer.

In accordance with embodiments, a tank filler neck which has a flow guide arranged in the filling tube and/or the filler head. It is advantageous if the filling tube is composed of plastic and, in particular, is designed as a blow-moulded plastic tube, and it is advantageous if the flow guide is designed to be shorter than the filling tube. The filler head is preferably composed of metal.

In accordance with embodiments, a motor vehicle which comprises a tank filler neck of the abovementioned type.

By virtue of the flexibility of the chosen material, the flow guide can be adapted better to different installation situations, this affecting especially the wide range of internal geometries of the filling tubes used. This makes the assembly of a tank filler neck significantly easier. Through the indicated choice of material, one and the same flow guide can also be used for different tank filler necks in different models.

Further advantageous embodiments and developments of the invention will become apparent from the dependent claims and from the description in conjunction with the figures.

It is advantageous if the flow guide is of single-part construction. The flow guide is then manufactured completely from an elastomer or from a thermoplastic elastomer. The reduced number of individual components further simplifies the assembly of a tank filler neck.

It is also advantageous if the flow guide is of multi-part construction. In particular, the flow guide has a flow guiding stub and a flow guiding tube connected thereto. In this way, a suitable material can be chosen for each part of the flow guide or for each function thereof.

It is particularly advantageous in this context if the flow guiding tube is composed of an elastomer or of a thermoplastic elastomer, and the flow guiding stub is composed of a thermoplastic or of a thermoset. In this way, on the one hand, good fitting of the flow guide in the filling tube/filler head is ensured and, on the other hand, the flow guiding tube can adapt well to the shape of the filling tube.

It is furthermore advantageous if the flow guiding stub and the flow guiding tube are connected releasably to one another, in particular by way of a latching connection. In this way, the flow guiding stub and the flow guiding tube can be connected easily and can nevertheless be composed of (completely) different materials.

However, it is also advantageous if the flow guiding stub and the flow guiding tube are connected non-releasably to one another, in particular being welded to one another. This, in turn, results in a small number of components for a tank filler stub, simplifying the assembly thereof. More specifically, the flow guiding stub and the flow guiding tube can be welded to one another if they are manufactured from a thermoplastic elastomer, or they can be connected to one another by vulcanization if the flow guiding stub and the flow guiding tube are composed of an elastomer.

The above embodiments and developments of the invention can be combined in any desired manner.

### DRAWINGS

Embodiments will be illustrated by way of example in the drawings and explained in the description below.

FIG. 1 illustrates an exploded view of a tank filler neck for a motor vehicle, in accordance with embodiments.

### DESCRIPTION

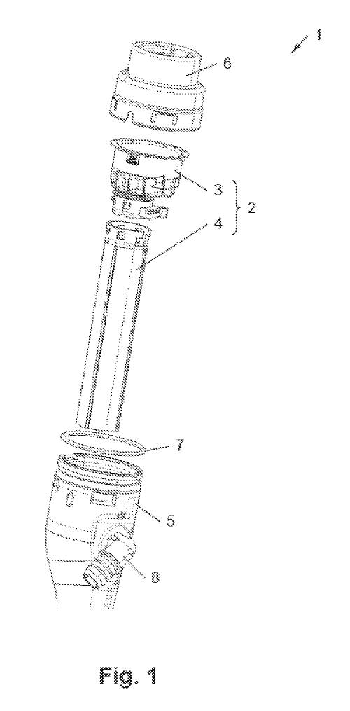

FIG. 1 illustrates a tank filler neck 1 for a motor vehicle, said filler neck 1 having a flow guide 2 comprising a flow guiding stub 3 and a flow guiding tube 4 connected thereto. Moreover, the tank filler neck 1 comprises a filling tube 5 composed of plastic, a filler head 6 composed of metal surrounding the filling tube 5 at an end thereof, and a seal 7 composed of an elastomer arranged between the filling tube 5 and the filler head 6. In a manner known per se, fuel is fed in via the filler head 6 during a fuelling process and flows via the filling tube 5 into a tank (not shown). To prevent return flow and splashing of the fuel, the flow guide 2 is provided.

In the example illustrated in FIG. 1, the flow guide 2 is of multi-part construction and, as already mentioned, comprises the flow guiding stub 3 and the flow guiding tube 4 connected thereto. The flow guiding stub 3 serves, inter alia, to fasten the flow guide 2 in the filling tube 5 or filler head 6, and also is structured to prevent return flow and splashing of the fuel. The flow guiding tube 4 is used for the further guidance of the fuel and, in particular, extends beyond the vent valve 8. However, it is advantageous if the flow guide 2 is of shorter design than the filling tube 5 leading to a fuel tank (not illustrated).

At least one of the flow guiding stub 3 and the flow guiding tube 4 is composed of an elastomer or of a thermoplastic elastomer. For example, the flow guiding tube 4 can be composed of an elastomer or of a thermoplastic elastomer, whereas the flow guiding stub 3 is composed of a thermoplastic or a thermoset. This ensures a good fit of the flow guide 2 in the filling tube 5 or the filler head 6. Moreover, the flow guiding tube 4 can adapt well to the shape of the filling tube 5. However, it is also conceivable, in particular, for both parts 4 to be composed of an elastomer or of a thermoplastic elastomer. In general terms, nitrile rubber (NBR), fluorocarbon rubber (FKM) or fluorosilicone (FVMQ) can be provided as the elastomer.

In the example illustrated, the flow guiding stub 3 and the flow guiding tube 4 are connected releasably to one another, more specifically with the aid of a latching connection. Alternatively, the flow guiding stub 3 and the flow guiding tube 4 could also be connected to one another in some other way. In particular, it is conceivable for the flow guiding stub 3 and the flow guiding tube 4 to be connected non-releasably to one another. More specifically, the flow guiding stub 3 and the flow guiding tube 4 could be welded to one another if they were manufactured from a thermoplastic elastomer, or could be connected to one another by vulcanization if the flow guiding stub 3 and the flow guiding tube 4 were composed of an elastomer. However, it is also conceivable for the flow guide 3 as a whole to be of single-part construction and to be composed entirely of an elastomer or of a thermoplastic elastomer.

In conclusion, it is noted that the component parts in the FIGURE may not be shown to scale. Position indications such as “right”, “left”, “top”, “bottom” and the like refer to the illustrated position of the respective component and will have to be adapted accordingly conceptually when said position changes. It is furthermore noted that the tank filler neck 1 illustrated or the flow guide 2 illustrated can, of course, have more components or fewer components than illustrated without departing from the basic concept of embodiments.

The term “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

What is claimed is:

1. A flow guide for a tank filler neck, comprising:
a flow guiding stub; and
a flow guiding tube connected to the flow guiding stub,
wherein the flow guiding stub and the flow guiding tube are composed at least partially of an elastomer or a thermoplastic elastomer.

2. The flow guide of claim 1, wherein the flow guiding stub and the flow guiding tube form a single-part component.

3. The flow guide of claim 1, wherein the flow guiding stub and the flow guiding tube form a multi-part component.

4. The flow guide of claim 1, wherein the flow guiding tube is composed of an elastomer or of a thermoplastic elastomer.

5. The flow guide of claim 1, wherein and the flow guiding stub is composed of a thermoplastic or of a thermoset.

6. The flow guide of claim 1, wherein the flow guiding stub and the flow guiding tube are connected releasably to one another.

7. The flow guide of claim 1, wherein the flow guiding stub and the flow guiding tube are connected non-releasably to one another.

8. The flow guide of claim 1, wherein the elastomer comprises nitrile rubber, fluorocarbon rubber or fluorosilicone.

9. A tank filler neck for a motor vehicle, comprising:
a filling tube;
a filler head surrounding the filling tube at an end thereof;
a seal composed of an elastomer arranged between the filling tube and the filler head; and
a flow guide arranged in the filling tube and/or the filler head, the flow guide including:
a flow guiding stub; and
a flow guiding tube connected to the flow guiding stub, wherein the flow guiding stub and the flow guiding tube are composed at least partially of an elastomer or a thermoplastic elastomer.

10. The tank filler neck of claim 9, wherein the flow guide is shorter in length than the filling tube.

11. The tank filler neck of claim 9, wherein the flow guiding stub and the flow guiding tube form a single-part component.

12. The tank filler neck of claim 9, wherein the flow guiding stub and the flow guiding tube form a multi-part component.

13. The tank filler neck of claim 9, wherein the flow guiding tube is composed of an elastomer or of a thermoplastic elastomer.

14. The tank filler neck of claim 9, wherein and the flow guiding stub is composed of a thermoplastic or of a thermoset.

15. The tank filler neck of claim 9, wherein the flow guiding stub and the flow guiding tube are connected releasably to one another.

16. The tank filler neck of claim 9, wherein the flow guiding stub and the flow guiding tube are connected non-releasably to one another.

17. The tank filler neck of claim 9, wherein the elastomer comprises nitrile rubber, fluorocarbon rubber or fluorosilicone.

18. A motor vehicle, comprising:
a tank filler neck including:
a filling tube;
a filler head surrounding the filling tube at an end thereof;
a seal composed of an elastomer arranged between the filling tube and the filler head; and
a flow guide arranged in the filling tube and/or the filler head, the flow guide including a flow guiding stub and a flow guiding tube connected to the flow guiding stub, wherein the flow guiding stub and the flow guiding tube are composed at least partially of an elastomer or a thermoplastic elastomer.
